(19) United States
(12) Patent Application Publication
(10) Pub. No.: US 2026/0357549 A1
(43) Pub. Date: Nov. 12, 2026

(54) Faucet

(71) Applicant: AS America, Inc., Piscataway, NJ (US)

(72) Inventors: XiaoPing Zheng, Guangzhou (CN); Xiaojing Ye, Edison, NJ (US)

(73) Assignee: AS America, Inc., Piscataway, NJ (US)

(21) Appl. No.: 19/120,887

(22) PCT Filed: Oct. 25, 2023
(86) PCT No.: PCT/US2023/035914

§ 371 Date: Apr. 14, 2025

(30) Foreign Application Priority Data
Oct. 27, 2022 (WO) PCT/CN2022/127992

(51) Int. Cl. E03C 1/04; F16K 11/00

(52) U.S. Cl. CPC E03C 1/0404; E03C 1/0403; F16K 19/006; E03C 2201/30

(57) ABSTRACT

A pull-down faucet assembly comprising a faucet body comprising an inner body part and an outer body part; a manifold; and a mixing valve, wherein the maniforld and the mixing valve are positioned in an interior of the faucet body, and the maniforld, the faucet inner body part, and the faucet outer body part comprise a thermoplastic. A faucet body comprising and inner body part and an outer body part, wherein the faucet inner body part and faucet outer body part comprise a thermoplastic.

The disclosure is directed to a pull-down faucet, in particular to a pull-down kitchen faucet having a plastic body and plastic inner waterway.

### BACKGROUND

Kitchen faucets should have bodies strong enough to withstand 500 psi water pressure and a valve locking nut torque strength of 11 Nm (Newton-meter). Kitchen faucet bodies therefore comprise zinc alloy or brass. Brass is an alloy of copper and zinc, and often contains small amounts of lead for machinability. Kitchen faucet bodies comprising zinc alloy or brass are also heavy and costly to produce.

Desired are kitchen faucets having bodies that are free of lead, that are lightweight, and that may be more easily manufactured to high precision.

### SUMMARY

Accordingly, disclosed is a pull-down faucet assembly comprising a faucet body comprising an inner body part and an outer body part; a manifold; and a mixing valve, wherein the manifold and the mixing valve are positioned in an interior of the faucet body, and the manifold, the faucet inner body part, and the faucet outer body part comprise a thermoplastic.

In some embodiments of the pull-down faucet assembly, the manifold, the faucet inner body part, and the faucet outer body part may comprise an engineering thermoplastic.

In some embodiments of the pull-down faucet assembly, the thermoplastic may comprise an engineering thermoplastic selected from one or more polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides, polyacetals, copolymers thereof, and blends thereof.

In some embodiments of the pull-down faucet assembly, the faucet outer body part may comprise one or more of an acrylonitrile-butadiene-styrene, a polysulfone, an acrylonitrile-styrene-acrylate, a cyclic olefin copolymer, or a polyphenylene oxide.

In some embodiments of the pull-down faucet assembly, the faucet inner body part may comprise one or more of a polyphthalamide, a polyphenylene sulfide, a polyether ether ketone, a polyethylenimine, a polysulfone, a polyethersulfone, or a polyphenylenesulfone.

In some embodiments of the pull-down faucet assembly, the faucet outer body part may comprise acrylonitrile-butadiene-styrene, and the faucet inner body part comprises polyphthalamide.

In some embodiments of the pull-down faucet assembly, the faucet inner body part may be an injection molded part.

In some embodiments of the pull-down faucet assembly, the faucet outer body part may be injection overmolded onto the faucet inner body part.

In some embodiments of the pull-down faucet assembly, the manifold may be configured to be coupled to the faucet inner body part with one or more screws or bolts.

In some embodiments of the pull-down faucet assembly, the faucet inner body part may comprise one or more portions configured to couple to the one or more screws or bolts.

In some embodiments of the pull-down faucet assembly, the faucet inner body part may comprise an inner threaded surface configured to threadingly couple to a locking nut.

In some embodiments of the pull-down faucet assembly, a manifold and a mixing valve may be positioned in an interior of the faucet body, and the manifold may be fluidly coupled to the mixing valve by a first inlet port connection, a second inlet port connection, and an outlet connection.

In some embodiments of the pull-down faucet assembly, the manifold may be fluidly coupled to a first inlet hose in flow communication with the first inlet port connection, a second inlet hose in flow communication with the second inlet port connection, and an outlet hose in flow communication with the outlet connection.

In some embodiments of the pull-down faucet assembly, the faucet body is capable to withstand 500 psi water pressure and a valve locking nut torque strength of 11 Nm.

In some embodiments of the pull-down faucet assembly, the faucet body may be metal-plated.

In some embodiments of the pull-down faucet assembly, it may further comprise a faucet spout having an upstream end coupled to the faucet body, and a downstream end removably coupled to a faucet spray head.

In some embodiments of the pull-down faucet assembly, the faucet spray head may be fluidly coupled to a pullout hose, and may be configured to be pulled out from the spout and returned to a docked position adjacent the spout downstream end.

Also disclosed is a faucet body comprising an inner body part and an outer body part, wherein the faucet inner body part and the faucet outer body part comprise a thermoplastic.

In some embodiments of the faucet body, the faucet inner body part and the faucet outer body part may comprise an engineering thermoplastic.

In some embodiments of the faucet body, the thermoplastic may comprise an engineering thermoplastic selected from one or more polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides, polyacetals, copolymers thereof, and blends thereof.

In some embodiments of the faucet body, the faucet outer body part may comprise one or more of an acrylonitrile-butadiene-styrene, a polysulfone, an acrylonitrile-styrene-acrylate, a cyclic olefin copolymer, or a polyphenylene oxide.

In some embodiments of the faucet body, the faucet inner body part may comprise one or more of a polyphthalamide, a polyphenylene sulfide, a polyether ether ketone, a polyethylenimine, a polysulfone, a polyethersulfone, or a polyphenylenesulfone.

In some embodiments of the faucet body, the faucet outer body part may comprise acrylonitrile-butadiene-styrene, and the faucet inner body part comprises polyphthalamide.

In some embodiments of the faucet body, the faucet inner body part may be an injection molded part.

In some embodiments of the faucet body, the faucet outer body part may be injection overmolded onto the faucet inner body part.

In some embodiments of the faucet body, the faucet inner body part may be in direct physical contact with the faucet outer body part.

In some embodiments of the faucet body, a manifold may be configured to be coupled to the faucet inner body part with one or more screws or bolts.

In some embodiments of the faucet body, the faucet inner body part may comprise one or more portions configured to couple to the one or more screws or bolts.

In some embodiments of the faucet body, the faucet inner body part may comprise an inner threaded surface configured to threadingly couple to a locking nut.

In some embodiments of the faucet body, the faucet body is capable to withstand 500 psi water pressure and a valve locking nut torque strength of 11 Nm.

In some embodiments of the faucet body, a manifold and a mixing valve may be positioned in an interior of the faucet body, the manifold comprises a thermoplastic, and the manifold may be fluidly coupled to the mixing valve by a first inlet port connection, a second inlet port connection, and an outlet connection.

In some embodiments of the faucet body, the manifold may be fluidly coupled to a first inlet hose in flow communication with the first inlet port connection, a second inlet hose in flow communication with the second inlet port connection, and an outlet hose in flow communication with the outlet connection.

In some embodiments of the faucet body, the faucet body may be metal-plated.

Also disclosed is a faucet assembly comprising the faucet body according to some embodiments.

### BRIEF DESCRIPTION OF THE DRAWINGS

This disclosure is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 shows a pull-down faucet assembly, according to some embodiments.

FIG. 2A shows a cross-section view of a faucet body assembly, according to some embodiments.

FIG. 2B and FIG. 2C show a faucet inner body part and a faucet body outer part overmolded onto a faucet inner body part, according to some embodiments.

FIG. 2D and FIG. 2E provide cross-section views of a faucet body assembly, according to some embodiments.

FIG. 2F provides a view of a manifold, according to some embodiments.

### DETAILED DESCRIPTION

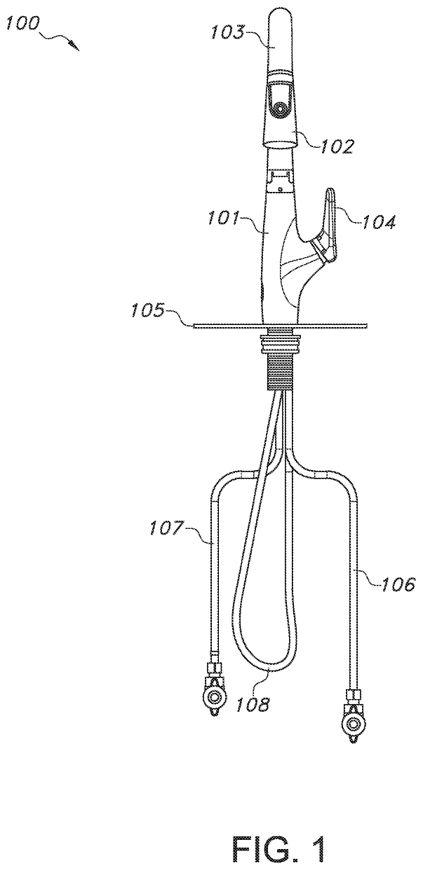

FIG. 1 provides a view of pull-down faucet assembly 100, according to an embodiment. Faucet assembly 100 comprises faucet body 101, positioned on deck 105 (or countertop, base, sink top, etc.). Faucet body 101 is coupled to handle 104, configured to provide on/off and water temperature functions. Spout 103 is coupled to faucet body 101, and spray head 102 is removably coupled to a downstream end of spout 103. Spray head 102 is configured to be pulled away from spout 103 and to be returned to a docked position as shown. Inlet hose 106, inlet hose 107 and outlet hose 108 are seen below deck 105. One of inlet hose 106 and inlet hose 107 is coupled to a hot water source and the other is coupled to a cold water source. One of inlet hose 106 and inlet hose 107 is configured to deliver hot source water, and the other cold source water to a mixing valve (not visible) positioned in faucet body 101. A mixing valve is configured to deliver mixed hot/cold water through outlet hose 108 to spray head 102. Spray head 102 is fluidly coupled to outlet hose 108. Outlet hose 108 comprises some “slack” in the embodiment shown, configured to allow spray head 102 to be pulled away from spout 103 and returned to a docket position.

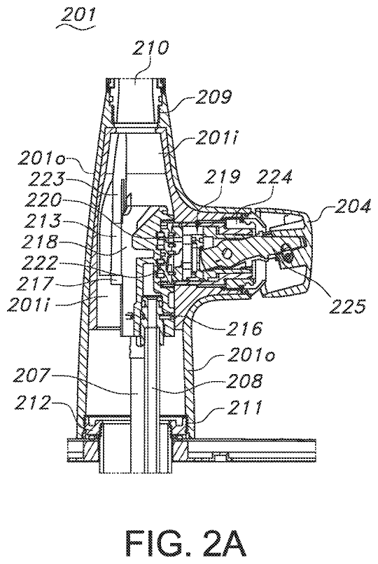

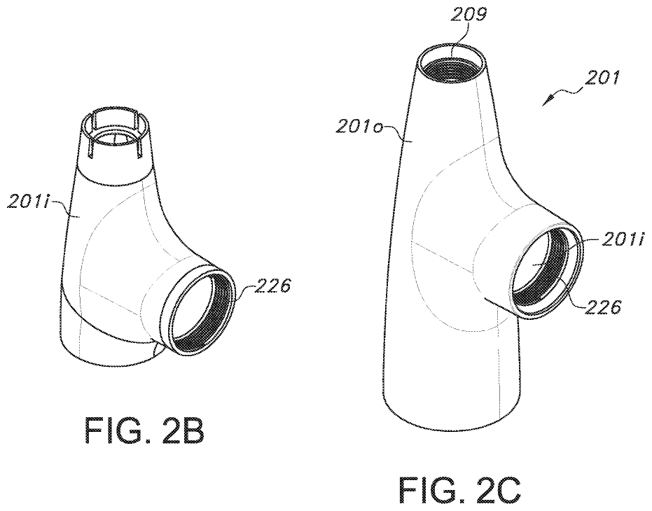

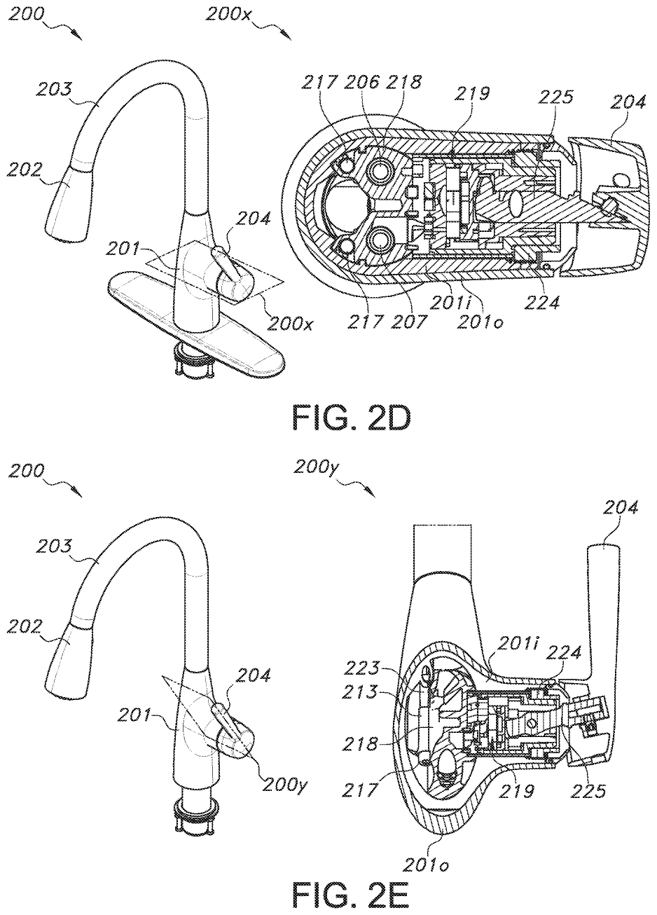

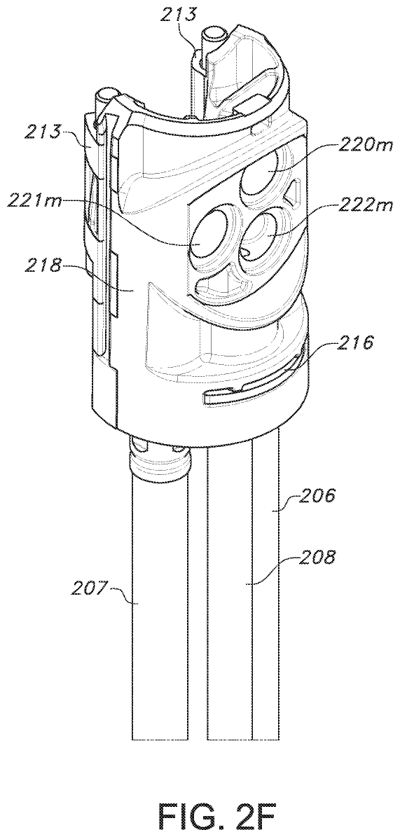

FIG. 2A provides a cross-section view of pull-down faucet body 201, according to an embodiment. Shown are inner body part 201i, comprising polyphthalamide (PPA). Inner body part 201i is injection molded. Outer body part 2010 comprises acrylonitrile-butadiene-styrene (ABS) overmolded onto inner body part 201i by injection molding. Manifold 218 also comprises an engineering thermoplastic. Manifold 218 is fluidly coupled to inlet hose 207, inlet hose 206 (not visible), and outlet hose 208. Manifold 218 comprises glass-filled polyphenylene sulfide. Mixing valve 219 contains 3 ports fluidly coupled to 3 ports of manifold 218 to form pairs of fluidly coupled ports, a first pair 220 configured to receive water from and in flow communication with water inlet hose 206, a second pair 221 (not visible) to receive water from and in flow communication with water inlet hose 207, and a third pair 222 configured to deliver mixed hot/cold water to outlet hose 208. An upper inner surface of inner body part 201i contains threaded surface 209, configured to mate with a threaded surface of adapter 210. Adapter 210 comprises glass-filled polyamide. A lower inner surface of inner body part 201i contains threaded surface 211, configured to threadingly mate with a threaded surface of adapter 212.

Inlet hoses 206 (not visible) and 207 are held in place to manifold 218 with hose retaining plate 216. Manifold 218 is fixed to inner body part 201i with two screws 217 (one shown). Inner body part comprises portion 223, configured to receive and mate with screw 217. Manifold 218 comprises cylinder-shaped portion 213 configured to receive screw 217. Locking nut 224 is threadingly coupled to inner body part 201i, and is configured to hold and secure mixing valve 219, manifold 218, and inner body part 201i together. Valve stem 225 is coupled to handle 204, and is configured such that, when handle 204 is moved horizontally relative to faucet body 201, valve 219 will open to dispense water. Valve stem 225 is also configured such that, when handle is moved rotationally relative to faucet body 201, a water temperature may be adjusted.

FIG. 2B provides a view of injection molded PPA inner body part 201i, according to an embodiment. Inner body part 201i comprises inner threaded surface 226, configured to threadingly mate with locking nut 224. FIG. 2C provides a view of thermoplastic faucet body 201, according to an embodiment. Outer body part 2010 is injection molded (overmolded) onto inner body part 201i.

FIG. 2D and FIG. 2E provide views of pull-down faucet assembly 200 on the left, and views of faucet body assembly cross-sections 200x and 200y, on the right, respectively, according to some embodiments. Faucet assembly 200 comprises faucet body 201, spout 203, spray head 202, and handle 204. Spray head 202 may be pulled out from spout 202 and returned to a docked position adjacent spout 202 as shown. Cross-section views 200x and 200y show inlet hoses 206 and 207, mixing valve 219, inner body part 201i, outer body part 2010, locking nut 224, and manifold 218. Screws 217 couple manifold 218 to inner body part 201i by passing through manifold portion 213 and coupling to inner body part portion 223.

FIG. 2F shows manifold 218, according to an embodiment. Shown are hollow, cylinder-shaped portions 213 configured to receive screws 217 for attaching manifold 218 to inner body part 201i. Also shown are manifold ports 220m, 221m, and 222m, configured to couple to corresponding ports of mixing valve 219 to form fluidly coupled connections 220, 221, and 222, respectively. Fluidly coupled port connection 220 is configured to receive source water from inlet hose 206 and to deliver the source water to mixing valve 219. Fluidly coupled port connection 221 is configured to receive source water from inlet hose 207 and to deliver the source water to mixing valve 219. One of inlet hose 206 and 207 is configured to deliver hot source water, and the other is configured to deliver cold source water. Fluidly coupled port connection 222 is configured to deliver mixed hot/cold water to outlet hose 208. Manifold 218 is fluidly coupled to inlet hoses 206 and 207, and to outlet hose 208. Outlet hose 208 is configured to fluidly couple to a pullout hose configured to run through body 201 and a spout and to fluidly couple to a pull-out spray head. Also shown is hose retaining plate 216.

A faucet inner body part and a faucet outer body part may each comprise a thermoplastic polymer, for example an engineering thermoplastic. Engineering thermoplastics include for example polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof. Polyamides include nylon and polyphthalamide (PPA). Polyacetals include polyoxymethylene (POM). In some embodiments, a thermoplastic polymer may comprise a glass-filled thermoplastic.

A manifold may also comprise a thermoplastic polymer, for instance an engineering thermoplastic as listed above.

A body inner part may be prepared by a thermoplastic injection molding technique. Injection molding techniques may provide for a high level of manufacturing precision. A body outer part may be overmolded onto a body inner part by thermoplastic injection molding. A body inner part may be in direct physical contact with a body outer part.

A faucet body may have a manifold positioned at an interior of the body. A manifold may likewise comprise a thermoplastic polymer, for example an engineering thermoplastic. A manifold may be prepared by thermoplastic injection molding techniques.

A faucet body may also have a mixing valve positioned at an interior of the body. A manifold may be configured to be fluidly coupled to a hot water inlet hose, a cold water inlet hose, and an outlet hose. A manifold may also be configured to be fluidly coupled to a mixing valve. A manifold may be configured to deliver hot source water and cold source water to a mixing valve via pairs of manifold and mixing valve ports fluidly coupled together. A manifold may be configured to receive mixed hot/cold water from the mixing valve via a pair manifold and mixing valve ports fluidly coupled together.

In some embodiments, a manifold may be affixed to a faucet inner body part with one or more screws or bolts. A manifold and faucet inner body part may comprise one or more portions configured to receive and couple to the one or more screws or bolts. The one or more screws or bolts may be threaded and configured to threadingly couple to a manifold portion and/or an inner body part portion configured to receive the screws or bolts. In some embodiments, the one or more screws or bolts may be threaded and the manifold portion and inner body part portion may not be threaded, and wherein the one or more screws are “self-tapping” or “self-drilling” screws. In other embodiments, one or more screws or bolts may not be threaded, and may have a smooth surface. A non-threaded bolt may affix a manifold to an inner body part with a tight fit in the inner body part. A manifold and a mixing valve may also be fixed to a faucet inner body part with a threaded locking nut. A faucet inner body part may comprise an inner threaded surface configured to threadingly couple to a locking nut.

A manifold and a mixing valve may be positioned in an interior of a faucet body. A manifold may also comprise a thermoplastic, for instance an engineering thermoplastic. A manifold may be fluidly coupled to a mixing valve by a first inlet port connection, a second inlet port connection, and an outlet connection. A manifold may be fluidly coupled to a first inlet hose in flow communication with the first inlet port connection, a second inlet hose in flow communication with the second inlet port connection, and an outlet hose in flow communication with the outlet connection. One of a first inlet hose and second inlet hose is configured to deliver hot source water to a mixing valve via a manifold, and the other is configured to deliver cold source water. An outlet hose is configured to deliver mixed hot/cold water from the mixing valve via a manifold to a spray head. An outlet hose may itself be fluidly coupled to a manifold and a spray head, or may be fluidly coupled to a manifold and a pullout hose, wherein the pullout hose is fluidly coupled to a spray head.

In some embodiments, a present faucet body is configured to withstand about 500 psi water pressure and/or have a have a valve locking nut torque strength of about 11 Nm.

In some embodiments, a faucet body may be metal-plated, for example chrome-plated.

A faucet body may have a downstream end configured to be coupled to an upstream end of a faucet spout. A faucet spout may comprise a downstream end configured to removably couple to a spray head. A spray head may be configured to be removably docked or positioned adjacent a faucet spout downstream end when not in use. A spray head may be fluidly coupled to an outlet hose, and configured to be removed, together with the outlet hose, from the spout during use, if desired, and then returned to a docked position adjacent the spout downstream end. In some embodiments, an outlet hose may be fluidly coupled to a pullout hose, wherein the pullout hose is fluidly coupled to a spray head and configured to be pulled out together with a spray head and returned to a docked position.

1. A pull-down faucet assembly comprising
a faucet body comprising an inner body part and an outer body part;
a manifold; and
a mixing valve,
wherein
the manifold and the mixing valve are positioned in an interior of the faucet body, and
the manifold, the faucet inner body part, and the faucet outer body part comprise a thermoplastic.

2. The pull-down faucet assembly according to claim 1, wherein the thermoplastic comprises an engineering thermoplastic.

3. The pull-down faucet assembly according to claim 2, wherein the thermoplastic is selected from one or more polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides, polyacetals, copolymers thereof, and blends thereof.

4. The pull-down faucet assembly according to claim 1, wherein the faucet inner body part is an injection molded part.

5. The pull-down faucet assembly according to claim 1, wherein the faucet outer body part is injection overmolded onto the faucet inner body part.

6. The pull-down faucet assembly according to claim 1, wherein the manifold is configured to be coupled to the faucet inner body part with one or more screws or bolts.

7. The pull-down faucet assembly according to claim 6, wherein the faucet inner body part comprises one or more portions configured to couple to the one or more screws or bolts.

8. The pull-down faucet assembly according to claim 1, wherein the faucet inner body part comprises an inner threaded surface configured to threadingly couple to a locking nut.

9. The pull-down faucet assembly according to claim 1, wherein a manifold and a mixing valve are positioned in an interior of the faucet body, and the manifold is fluidly coupled to the mixing valve by a first inlet port connection, a second inlet port connection, and an outlet connection.

10. The pull-down faucet assembly according to claim 9, wherein the manifold is fluidly coupled to a first inlet hose in flow communication with the first inlet port connection, a second inlet hose in flow communication with the second inlet port connection, and an outlet hose in flow communication with the outlet connection.

11. The pull-down faucet assembly according to claim 1, wherein the faucet body is capable to withstand 500 psi water pressure and a valve locking nut torque strength of 11 Nm.

12. The pull-down faucet assembly according to claim 1, wherein the faucet body is metal-plated.

13. The pull-down faucet assembly according to claim 1, comprising a faucet spout having an upstream end coupled to the faucet body, and a downstream end removably coupled to a faucet spray head.

14. A faucet body comprising an inner body part and an outer body part, wherein the faucet inner body part and the faucet outer body part comprise a thermoplastic.

15. The faucet body according to claims 14, wherein the thermoplastic is selected from one or more polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides, polyacetals, copolymers thereof, and blends thereof.

16. The faucet body according to claim 14, wherein the faucet inner body part is an injection molded part.

17. The faucet body according to claim 14, wherein the faucet outer body part is injection overmolded onto the faucet inner body part.

18. The faucet body according to claim 14, wherein the faucet inner body part is in direct physical contact with the faucet outer body part.

19. The faucet body according to claim 14, wherein a manifold is configured to be coupled to the faucet inner body part with one or more screws or bolts.

20. The faucet body according to claim 14, wherein the faucet inner body part comprises an inner threaded surface configured to threadingly couple to a locking nut.
